(19) United States
(12) Patent Application Publication
(10) Pub. No.: US 2004/0036338 A1
(43) Pub. Date: Feb. 26, 2004

(54) Vehicle seat provided with a hinge mechanism

(76) Inventors: Emmanuel Lardais, Legast (FR); Yann Reubeuze, Landigou (FR); Francois Cilliere, La Selle La Forge (FR); Paul Jaudouin, St Georges Des Groseilliers (FR)

Correspondence Address: MCCRACKEN AND FRANK, 200 W. ADAMS STREET, SUITE 2150, CHICAGO, IL, 60606, US

(21) Appl. No.: 10/612,430

(22) Filed: Jul. 2, 2003

(30) Foreign Application Priority Data
Jul. 5, 2002 (FR) 02 08480

(51) Int. Cl. B60N 2/22

(52) U.S. Cl. 297/367

(57) ABSTRACT

A vehicle seat comprises a seat back mounted to pivot on a seat proper via first and second hinges, each of which has two pivotally mounted cheek plates that can be locked by locking members mounted to move inside the cheek plates, the locking members of the first hinge being mounted to slide radially only, and the locking members of the second hinge being mounted to slide radially and with a certain amount of play in a circumferential direction.

### FIELD OF THE INVENTION

The present invention relates to vehicle seats provided with hinge mechanisms.

More particularly, among such vehicle seats, the invention relates to a vehicle seat having first and second sides, said seat comprising a seat proper and a seat back mounted to pivot relative to the seat proper by means of a hinge mechanism comprising first and second hinges which are respectively disposed on the first and second sides of the seat, and each which comprises:

first and second cheek plates mounted to pivot relative to each other about an pivot axis that is common to the first and second hinges, both of the first cheek plates of the first and second hinges being secured to a first seat element selected from the seat proper and the seat back, while the second cheek plates of the first and second cheek plates are secured to a second seat element chosen from the seat proper and the seat back, the second cheek plate of each hinge being provided with a first set of teeth forming at least one circular arc centered on the pivot axis;

a plurality of locking members, each of which is provided with a second set of teeth having an angular pitch that is identical to the angular pitch of the first set of teeth, each locking member being mounted to move on the first cheek plate in a substantially radial direction between firstly an active position in which the second set of teeth of each locking member is in engagement with the first set of teeth of the second cheek plate so as to prevent the first and second cheek plates from moving relative to each other, and secondly a retracted position in which the second set of teeth of each locking member does not co-operate with the first set of teeth of the second cheek plate so as to enable the first and second cheek plates to pivot relative to each other; and

a control device suitable for placing the plurality of locking members either in the active position or in the retracted position, the seat further comprising a mechanical coupling which interconnects the control devices of the first and second hinges.

### BACKGROUND OF THE INVENTION

Document FR-A-2 766 137 describes an example of such a seat.

The seat described in that document gives complete satisfaction but it suffers from the drawback that, due to the tolerances for assembling the structure of the seat, combined with the tolerances for assembling the seat to the floor of the vehicle, and also combined with the small amount of angular play of the first and second hinges relative to each other, the teeth on the locking members can find themselves in angular positions that differ from one hinge to the other relative to the teeth integral with the second cheek plates of the respective hinges.

In certain cases, that can prevent the hinges from re-locking fully after unlocking, in particular when the angular offset between the teeth on the locking members and the teeth on the second cheek plate is in a first direction in the first hinge and in a second direction that is opposite to the first direction in the second hinge.

In which case, the two hinges are latched only improperly after re-locking, so that the seat back then has relatively little resistance to the torque that can be exerted on it about its pivot axis, in particular when the vehicle is subjected to a sudden impact.

Even though improper latching of the hinges is quite rare, such improper latching can be very dangerous to the user of the seat particularly (but not exclusively) when the back of the seat carries a seatbelt.

### OBJECTS AND SUMMARY OF THE INVENTION

An object of the present invention is to mitigate that drawback.

To this end, according to the invention, in a seat of the type in question, each locking member of the first hinge is mounted to move radially only on the first cheek plate of said first hinge, and each locking member of the second hinge is further mounted on the first cheek plate of said second hinge with a certain amount of play in a direction that is circumferential to the radial direction so as to make it possible, when each locking member of the second hinge is in the active position, for each second set of teeth to mesh fully with the first set of teeth of the second hinge.

In preferred embodiments of the invention, it is optionally possible to make use of one or more of the following provisions:

the circumferential play of the second set of teeth of each locking member of the second hinge is equal to not less than twice the distance between two adjacent teeth of the first set of teeth of said second hinge;

when each locking member is in the retracted position, the first cheek plate and each locking member of the second hinge are adapted to enable each second set of teeth of said locking members to be placed in an identical position relative to said first cheek plate of the second hinge;

each locking member of the second hinge is mounted to slide in the radial direction between two guides that are normally separated from the locking member by said circumferential play;

the two guides have respective bearing zones, at least one of which serves to make substantially point contact with the locking member when it is in the active position;

the two guides of each locking member are adapted to co-operate with respective ones of two bearing edges belonging to the locking member by applying said locking member against the first set of teeth of the second hinge by a wedging effect when the hinge mechanism is subjected to torque greater than a normal value;

the two bearing edges of each locking member form respective wedges with the second set of teeth of said locking members, which wedges project laterally on either side of said locking member;

each locking member comprises firstly a slug carrier mounted to slide radially only between two guides, the slug carrier serving to co-operate with the control device of the second hinge, and secondly a slug provided with the second set of teeth serving to co-operate with the first set of teeth of the second hinge, said slug being mounted on the slug carrier with play equal to not less than said circumferential play;

the slug includes a projecting portion which diverges radially inwards and which is held captive with play in a notch in the slug carrier, the projecting portion of said slug being urged against the notch in the slug carrier by a spring disposed between the slug and said slug carrier, and, when the locking member is in the active position, the slug carrier has a bearing surface which pushes the slug back against the second cheek plate so as to cause the second set of teeth of the slug to cooperate with the first set of teeth of said second cheek plate;

the control device of the second hinge comprises:

a rotary cam which is urged resiliently towards a rest position in which said cam places each locking member in the active position; and

a control plate which is secured to the cam and which covers each locking member at least in part, said control plate being provided with cutouts adapted to co-operate with projecting pegs provided on each locking member so as to move each locking member simultaneously towards the retracted position when the cam is moved into an actuating position;

the control device of the second hinge comprises:

a plurality of springs which connect respective ones of the plurality of locking members to the first cheek plate of the second hinge, each spring urging the locking member that is associated with it towards the active position; and

a rotary control plate which is urged resiliently towards a rest position and which covers each locking member at least in part, said control plate being provided with cutouts adapted to co-operate with projecting pegs provided on each locking member so as to move each locking member simultaneously towards the retracted position when said control plate is moved to an actuating position;

each cutout in the control plate has a ramp-shaped cam edge which is adapted to hold the corresponding locking member in the active position when the control plate is in the rest position; and

the mechanical coupling is a lost-motion mechanical coupling which interconnects the control devices of the first and second hinges with a certain amount of angular play, the mechanical coupling being adapted to enable the control device of the second hinge to place the locking members in the active position when the control device of the first hinge is driven to move the locking members of said first hinge from the retracted position to the active position, said mechanical coupling further being adapted to enable the control devices of the first and second hinges to place the locking members of said first and second hinges simultaneously in the retracted position.

### BRIEF DESCRIPTION OF THE DRAWINGS

Other characteristics of the invention appear on reading the following description of embodiments of it, given by way of non-limiting example and with reference to the accompanying drawings.

In the drawings:

FIGS. 1 and 2 are respectively a side view and a rear view of a vehicle seat in an embodiment of the invention;

FIG. 3 is a vertical section view showing the two hinges that connect the seat back to the seat proper of the seat shown in FIGS. 1 and 2;

FIG. 4 is a section view on line IV-IV of FIG. 3, showing the first hinge in its locked position;

FIG. 4a is a detail view showing respectively the set of teeth on a locking member and the set of teeth on the second cheek plate of the first hinge when the first and the second cheek plates are angularly offset relative to each other;

FIG. 5 is a section view on line V-V of FIG. 3, showing the second hinge in its unlocked position;

FIG. 6 is a detail view seen looking in the direction V shown in FIG. 3;

FIG. 7 is a view similar to FIG. 5, the set of teeth on the second cheek plate not being angularly offset in phase relative to the sets of teeth on the locking member;

FIG. 8 is a view similar to FIG. 5, the set of teeth on the second cheek plate of the second hinge being angularly offset in phase relative to the sets of teeth on the locking member;

FIG. 9 is a section view of the second hinge in a second embodiment of the invention, the second hinge being in the unlocked position;

FIG. 10 is a view similar to FIG. 9, the set of teeth on the second cheek plate of the second hinge not being angularly offset in phase relative to the sets of teeth on the locking members; and

FIG. 11 is a view similar to FIG. 9, the set of teeth on the second cheek plate of the second hinge being angularly offset in phase relative to the sets of teeth on the locking members.

### MORE DETAILED DESCRIPTION

In the various figures, like references designate elements that are identical or similar.

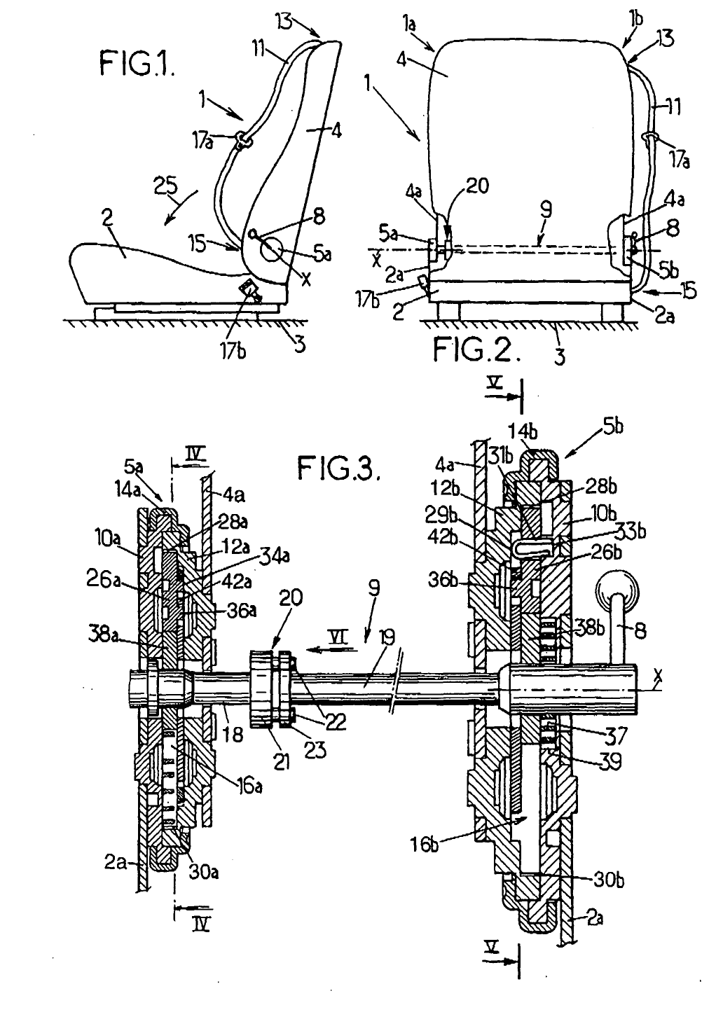

As shown diagrammatically in FIGS. 1 and 2, the invention relates to a vehicle seat 1, in particular a front seat of a motor vehicle. Said seat comprises a seat proper 2 mounted on the floor 3 of the vehicle and a seat back 4 mounted to pivot on the seat proper 2 about a horizontal or transverse axis X. More precisely, the rigid framework 4a of the seat back is connected to the rigid framework 2a of the seat proper 2 via a first hinge 5a and a second hinge 5b, said hinges being situated at respective ones of the first and the second sides 1a, 1b of the seat. The first and second hinges 5a, 5b are controlled by a handle 8 situated on the second side 1b of the seat. The two hinges are interconnected by a coupling 9 extending horizontally and transversely relative to the seat.

In addition, in the example being considered, the seat 1 has a seatbelt 11 which is connected to the top of the seat back and to the seat proper at respective coupling points, namely a top coupling point 13 and a bottom coupling point 15, on the second side 1b of the seat. The seatbelt 11 conventionally has a buckle 17a which is adapted to come to fasten removably into a latch 17b which is fixed, for example, to the seat proper on the first side of the seat.

It should be noted that the top coupling point 13 may be constituted, for example, by a guide at which the belt 11 penetrates into the seat back, said belt being deflected from the guide to a seatbelt reel situated inside the seat, optionally in a position remote from the top coupling point 13.

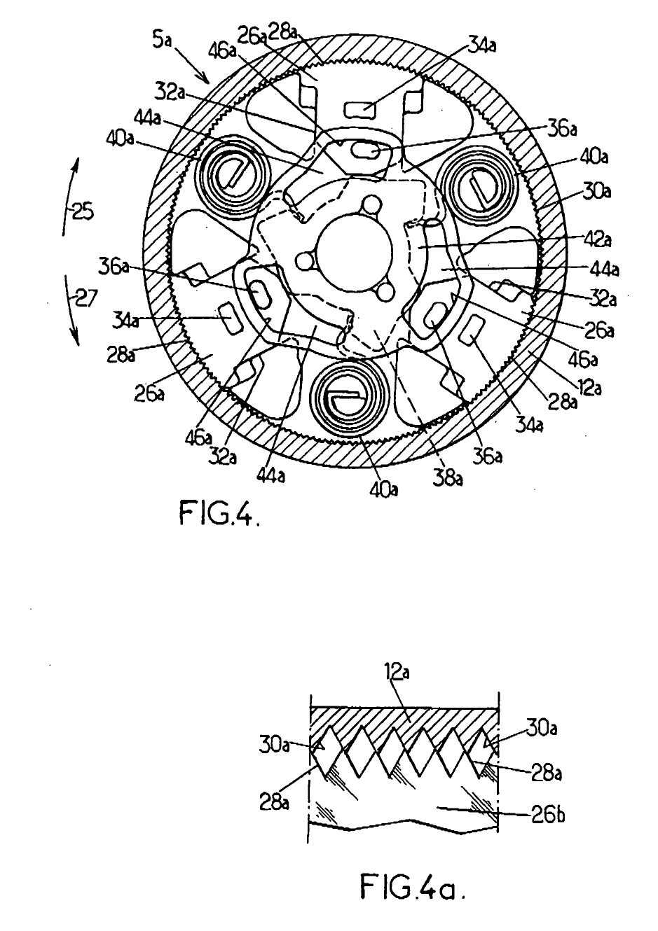

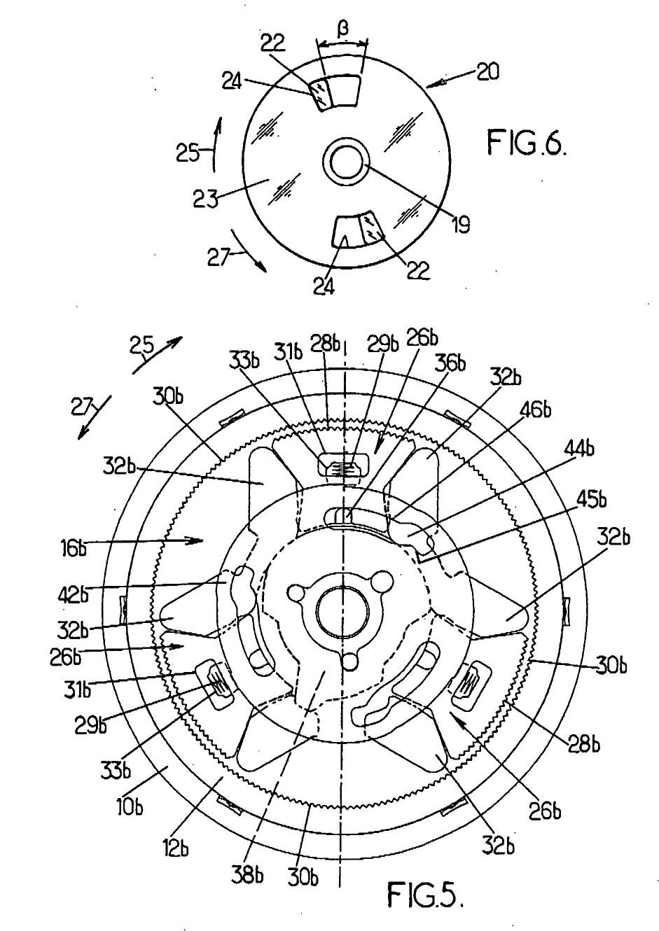

As shown in more detail in FIGS. 3 and 4, the first hinge 5a comprises:

a stationary metal cheek plate 10a which is secured to the rigid framework 2a of the seat proper;

a moving metal cheek plate 12a which is secured to the framework 4a of the seat back;

a metal band 14a which is crimped around the peripheries of the stationary and moving cheek plates while co-operating with them to define a closed circular housing; and

a locking device 16a which is contained in the corresponding housing and which is adapted to prevent the moving cheek plate 12a from moving relative to the corresponding stationary cheek plate 10a so long as the handle 8 is not actuated.

The locking mechanism 16a, which is shown in more detail in FIG. 4, and which, in the example under consideration, comprises:

three metal locking members 26a which are disposed at substantially 120° intervals relative to one another, and each of which has an outwardly-directed set of teeth 28a adapted to come into engagement with an inwardly-directed circular set of teeth 30a centered on the axis X and provided in the moving cheek plate 12a of the first hinge 5a; each of the locking members 26a is mounted to slide radially only, between two guides 32a that are secured to the stationary cheek plate 10a, so that the locking members 26a can be moved between firstly an active position (FIG. 4) in which the sets of teeth 28a on said locking members 26a are in engagement with the set of teeth 30a on the moving cheek plate 12a so as to lock the first hinge 5a, and secondly a retracted position (not shown) in which the locking members 26a do not co-operate with the set of teeth 30a on the moving cheek plate 12a and in which the locking members 26a are spaced apart to the maximum extent from the set of teeth 30a; each locking member 26a is further provided with two pegs 34a, 36a which project axially towards the moving cheek plate 12a;

a metal cam 38a which is secured to the handle 8 and which causes the locking members 26a to slide radially relative to the guides 32a;

springs 40a which are mounted on the stationary cheek plate 10a, and which urge the cam 38a in the angular direction 27 towards a rest position in which said cam places the locking members 26a in their engagement active position, it being possible for said cam 38a to pivot in the angular direction 25 as far as an active position while enabling said locking members 26a to slide radially towards their fully retracted position, thereby unlocking the first hinge 5a; and

a control mask formed by a rigid metal plate 42a which is connected rigidly to the cam 38a and which extends radially between said cam 38a and the moving cheek plate 12a while covering the locking members 26a in part, said plate being provided with three cutouts 44a in which the pegs 36a on the locking members 26a are engaged, each of the pegs 36a co-operating with a cam edge 46a which defines the corresponding cutout 44a radially outwards and which is shaped to co-operate with the peg 36a that is associated with it so as to move the corresponding locking member 26a radially inwards when the cam 38a turns in the angular direction 25.

The cam 38a, the springs 40a and the control plate 42a thus form a control device adapted to place the plurality of locking members 26a in their active positions or in their retracted positions.

Thus, as can be seen in FIG. 4, each locking member 26a is mounted to slide radially in a channel defined between two rigid guides 32a that belong to the stationary cheek plate 10a and that flank the locking member 26a without any play in the circumferential direction.

The second hinge 5b, shown in FIGS. 3 and 5, comprises:

a stationary metal cheek plate 10b which is secured to the rigid framework 2a of the seat proper;

a moving metal cheek plate 12b which is secured to the framework 4a of the seat back;

a metal band 14b which is crimped around the peripheries of the stationary and moving cheek plates while co-operating with them to define a closed circular housing; and

a locking device 16b which is contained in the housing of said second hinge 5b, and which is adapted to prevent the moving cheek plate 12b from moving relative to the stationary cheek plate 10b, ignoring a certain amount of play, so long as the handle 8 is not actuated.

FIGS. 5, 7, and 8 show a first embodiment of the locking device 16b with play which, in the example under consideration, comprises:

three locking members 26b which are disposed at substantially 120° intervals relative to one another, and each of which has an outwardly-directed set of teeth 28b adapted to come into engagement with an inwardly-directed circular set of teeth 30b centered on the axis X and provided in the moving cheek plate 12b; each of the locking members 26b is mounted to move in a channel defined by two guides 32b that are secured to the stationary cheek plate 10b, so that the locking members 26b move between firstly an active position (FIGS. 7 and 8) in which the sets of teeth 28b on said locking members 26b are directly in engagement with the set of teeth 30b on the moving cheek plate 12b, and secondly a retracted position (FIG. 5) in which the locking members 26b do not co-operate with the set of teeth 30b on the moving cheek plate and in which the locking members 26b are spaced apart to the maximum extent from the set of teeth 30b; each locking member 26b is further provided with a peg 36b which projects axially towards the moving cheek plate 12b;

a control mask formed by a rigid metal plate 42b which is connected rigidly to a cam 38b and which extends radially between said cam 38b and the moving cheek plate 12b while covering the locking members 26b in part, said plate also being provided with three cutouts 44b in which the pegs 36b on the locking members 26b are engaged, each of the pegs 36b co-operating with a cam edge 46b which defines the corresponding cutout 44b radially outwards and which is shaped to co-operate with the peg 36b that is associated with it so as to move the corresponding locking member 26b radially inwards when the cam 38b and the plate 42b turn in the angular direction 25; it being possible for each of the pegs 36b to co-operate with a cam edge 45b that defines the corresponding cutout 44b radially inwards, and that is shaped to hold the corresponding locking member 26b in its active position when the control plate 42b and the cam 38b turn in the angular direction 27 towards their rest position; and

springs 29b that are in the form of resilient blades folded over in substantially U-shaped manner; each spring 29b passes through a hole 31b provided in the locking member 26b that is associated with it, and penetrates into a notch 33b provided in the stationary plate 10b of the second hinge 5b (FIG. 3); each spring 29b resiliently urges the locking member 26b that is associated with it towards its active position in which the set of teeth 28b on said locking member 26b cooperates with the set of teeth 30b on the moving cheek plate 12b; and

a spring 37 mounted, for example, in a stamped dish-shaped setback 39 formed in the stationary cheek plate 10b (FIG. 3); said spring 37 urges the cam 38b and therefore the control plate 42b in the angular direction 27, towards a rest position in which the cam surface 46b of the control plate enables the pegs 36b on the locking members 26b to move towards the set of teeth 30b on the moving cheek plate 12b under the action of springs 29b which resiliently urge the locking members 26b so that their sets of teeth 28b co-operate with the set of teeth on the moving cheek plate 12b (FIG. 7).

In this first embodiment, each locking member 26b has a wide head 47 which is provided with the set of teeth 28b, said wide head having bearing edges 48 which diverge radially outwards. Relative to a radial direction R, each bearing edge 48 of the head 47 forms, an angle α lying, for example, in the range 30° to 60°. The bearing edges 48 of the wide head 47 are flanked with some circumferential play by two guide ramps 33 belonging to respective ones of the two guides 32b adjacent to the locking member 26b, when said locking member 26b is in the active position as shown in FIG. 7.

In addition, as can be seen in FIGS. 5 and 7, each locking member 26b has a rear portion 49 provided with two side edges 50 which diverge radially inwards towards the pivot axis X. The rear portion 49 of each locking member 26b also has a concave portion 51 which cooperates with the two side edges 50 to define two vertices 52, at least one of which is in contact with one of the adjacent guides 32b when the locking member 26b is in the retracted position (FIG. 5).

More precisely, when the locking members 26b are in the retracted position as shown in FIG. 5, at least one of the two vertices 52 of any one locking member 26b is in contact with one of the side edges 53 belonging to the two guides 32, the two side edges 53 forming wedges with the guide ramps 33 also belonging to the two guides 32b.

The two side edges 53 also have recesses or setbacks 54 serving to form bearing zones, at least one of which is designed to make substantially point contact with one of the two vertices 52 of the locking member 26b when said locking member is in the active position as shown in FIG. 7 or FIG. 8, as described in more detail below.

Thus, by means of these provisions, each locking member 26b can pivot about an axis parallel to the pivot axis X, so that the set of teeth 28b on the locking member can move with a certain amount of play in the circumferential direction relative to the stationary cheek plate 10a.

The play that is circumferential and/or transverse relative to the radial direction is limited by the distance that separates the two recesses 54 from the two vertices 52 of the locking member 26b. Said distance is determined so that the circumferential play of the set of teeth 28b of each locking member 26b is equal to not less than twice the distance between two adjacent teeth in the set of teeth 30b on the moving cheek plate 12b. Said circumferential play also makes it possible for the sets of teeth 28b on the locking members 26b to be always engaged fully in the set of teeth 30b, regardless of the angular offset of the moving cheek plate 12b relative to the stationary cheek plate 10b of the second hinge 5b.

In the embodiment shown in FIG. 3, the coupling 9 which interconnects the two hinges 5a and 5b is advantageously made up by two rigid bar segments 18, 19 which extend along the pivot axis X, and which are mounted to pivot about said pivot axis X, while being connected together with some angular play by a lost motion device 20.

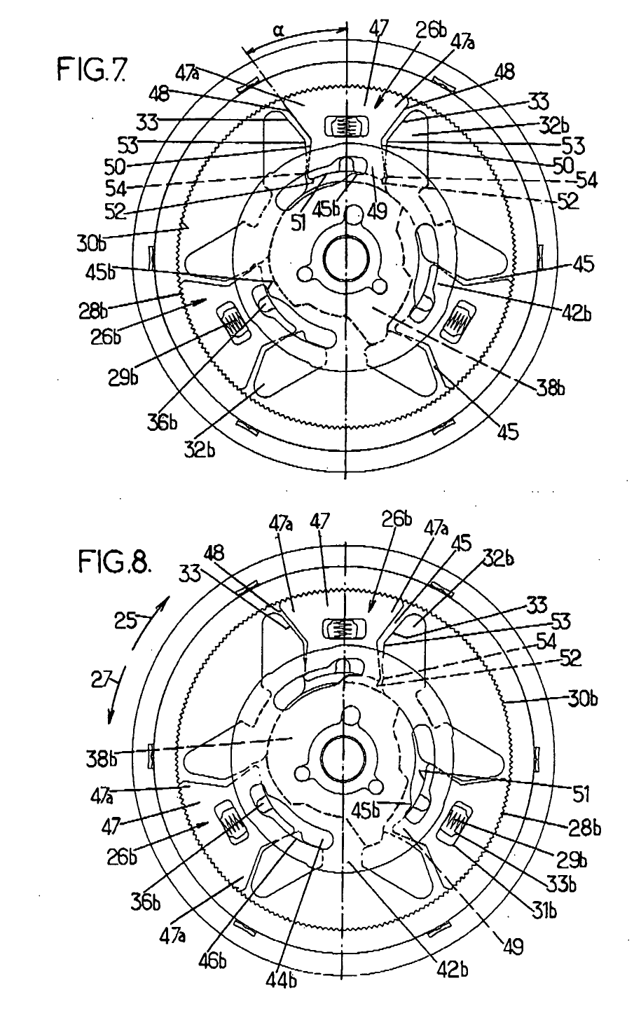

In the example under consideration, the lost motion device 20, which can be seen clearly in FIGS. 3 and 6, comprises:

firstly, a radial plate 21 which is secured to the bar segment 18 that is connected to the cam 38a of the first hinge 5a, and which is extended axially towards the bar segment 19 via two eccentric drive fingers 22; and

secondly, a radial plate 23 which is secured to the bar segment 19 that is connected to the cam 38b of the second hinge 5b, and to the handle 8, and which is provided with two circular arc shaped oblong slots 24 (FIG. 6), in which the two drive fingers 22 are engaged. When the two hinges 5a, 5b are in the rest position, the drive fingers 22 are in abutment against respective first ends of the oblong slots 24 so that:

when the handle 8 is actuated in the angular direction 25, the drive fingers 22 are driven immediately by the plate 23; and

if the bar segment 18 is blocked, while the handle 8 is not in the rest position, then said handle 8 can continue to move with the bar segment 19 in the angular direction 27 over a certain angular stroke β before the second ends of the oblong slots 24 come into abutment against the drive fingers 22.

By way of example, the stroke β may lie in the range 5° to 10°.

The above-described seat operates as follows.

When the passenger in the seat 1 wishes to adjust the inclination of the seat back 4, said passenger actuates the handle 8 by turning it in the angular direction 25, thereby simultaneously driving the cams 38a, 38b of the two hinges 5a, 5b to their retracted positions so that the locking members 26a, 26b of the two hinges move radially inwards to their fully retracted positions.

The passenger in the seat can then adjust the inclination of the seat back 4 by acting directly on the seat back, e.g. by pushing backwards by leaning back, or else by allowing it to move forwards under the effect of one or more springs inside the seat back (not shown).

Once the user has adjusted the inclination of the back of the seat, and released the handle 8, the cams 38a, 38b of the two hinges 5a, 5b move in the angular direction 27 towards their rest positions under the effect of the springs 40a in the first hinge 5a, and under the effect of the central spring 37 in the second hinge 5b. Under the effect respectively of the cam 38a and of the springs 29b, the locking members 26a, 26b of the two hinges slide radially outwards towards the corresponding sets of teeth 30a, 30b.

While the locking members are moving radially outwards, four situations can occur.

In a first situation, if the sets of teeth 28a, 28b on the locking members 26a, 26b are exactly in register with respective ones of the corresponding sets of teeth 30a, 30b, the sets of teeth 28a, 28b on the locking member 26a, 26b are then fully engaged in respective ones of the sets of teeth 30a, 30b on the moving cheek plates 12a, 12b, and, in this situation, the two hinges 5a and 5b are automatically locked.

In a second situation, the teeth 28a on the locking members 26a of the first hinge 5a are exactly in register with the set of teeth 30a on the moving cheek plate 12a, and the sets of teeth 28b on the locking members 26b of the second hinge 5b are not in register with the set of teeth 30b on the moving cheek plate 12b. In this situation, the sets of teeth 28a on the locking members 26a of the first hinge 5a are fully engaged in the set of teeth 30a on the moving cheek plate 12a, and, under the effect of the circumferential play of each locking member 26b relative to the stationary cheek plate 10b, each set of teeth 28b is also fully engaged in the set of teeth 30b on the moving cheek plate 12b. The two hinges 5a, 5b are also fully locked.

In the third situation, the sets of teeth 28a on the locking members 26a of the first hinge 5a are not in register with the set of teeth 30a on the moving cheek plate 12a, while the sets of teeth 28b on the locking members 26b of the second hinge 5b are exactly in register with the corresponding set of teeth 30b. In this situation, the sets of teeth 28a on the locking members 26a of the first hinge 5a nevertheless engage in an intermediate position with the set of teeth 30a on the moving cheek plate 12a. The intermediate position is shown in FIG. 4a which clearly shows that the sets of teeth 28a on the locking members 26a cannot mesh fully into the corresponding set of teeth 30a. The cam 38a of the first hinge 5a then remains blocked in an intermediate position between its active position and its rest position. However, by means of the presence of the lost-motion device 20, the cam 38b and therefore the control plate 42b can continue to turn in the angular direction 27 about the pivot axis X, under the effect of the central spring 37. The locking members 26b thus continue to slide radially outwards towards the set of teeth 30b on the moving cheek plate 12b until they come to mesh fully with said set of teeth 30b which is exactly in resister with the sets of teeth 28b on the locking members 26 so as to lock the hinge 5b. In addition, when the user of the seat leans against the seat back 4 and the sets of teeth 28a on the locking members 26a of the first hinge 5a are offset angularly relative to the corresponding set of teeth 30a, as shown in FIG. 4a, the seat back is subjected to elastic deformation that is relatively small but that is sufficient to offset the sets of teeth 28a angularly relative to the set of teeth 30a on the moving cheek plate 12a of the first hinge 5a. This angular offset due to the seat back deforming thus enables the sets of teeth 28a on the locking members 26a to come into the position of maximum engagement with the corresponding set of teeth, so that the first hinge 5a also locks.

In the fourth situation, the sets of teeth 28a, 28b on the locking members 26a, 26b are not in register with the corresponding sets of teeth 30a, 30b, it being possible for this alignment error to differ from one hinge to the other. The sets of teeth 28a of the second hinge then co-operate in an intermediate position with the set of teeth 30a of the first hinge 5a, as shown in FIG. 4, while, by means of the presence of the lost-motion device, the sets of teeth 28b on the locking members 26b continue to move towards the set of teeth 30b on the moving cheek plate 12b. The circumferential play which is equal to not less than twice the distance between two adjacent teeth of the set of teeth 30b then enables the locking members 26b or more exactly their sets of teeth 28 to move circumferentially and/or laterally relative to the stationary cheek plate 10a so that said sets of teeth 28b mesh fully with the sets of teeth 30b on the moving cheek plate 12b, thereby locking the second hinge 5b. The first hinge 5a also locks, when the user leans on the seat back 4 as described above.

In addition, as can be seen in FIGS. 7 and 8, the bearing edges 48 of each locking member 26b of the second hinge 5a form wedges 47a with the set of teeth 28b, which wedges project laterally relative to the locking member in question, each of the wedges 47a being disposed facing a guide ramp 33 belonging to the corresponding guide 32b.

While the seat is in normal use, and depending on whether the sets of teeth 28b are meshed fully with the corresponding set of teeth 30b without the locking members 26b moving (FIG. 7), or whether said sets of teeth 28b are meshed fully with the corresponding set of teeth 30b after said sets of teeth 28b have been moved circumferentially (FIG. 8), there is always an empty space 45 between the guide ramp 33 of one of the guides 32b and the bearing edge 48 of the locking member 26b. Thus, when the back of the seat is subjected to particularly high pivot torque in particular due to the vehicle undergoing an accident, the moving cheek plate 12b then starts to pivot relative to the stationary cheek plate 10b and one of the guide ramps 33 of the guides 32b is applied strongly against one of the wedges 47a. Whereupon, the set of teeth 28b on each locking member 26b is applied strongly against the set of teeth 30b on the moving cheek plate 12b by means of a wedging effect while considerably reinforcing the strength of the second hinge 5b.

In addition, the two guide ramps 33 of the guides 32b adjacent to the same locking member 26b also make it possible, by co-operating with the side edges 48 of each locking member 26b, to re-center said locking member 26b relative to the two guides 32b when said locking member is returned to its retracted position as shown in FIG. 5.

This first embodiment described with reference to FIGS. 1 to 8 includes a coupling bar 9 provided with a lost-motion device 20. However, it is also possible to replace said coupling bar 9 with a rigid coupling bar which is not provided with such a lost-motion device, and which extends between two ends secured respectively to the cam 38a of the first hinge 5a and to the second cam 38b of the second hinge 5b.

In such a case, the first hinge 5a re-locks automatically when the user of the seat leans back against the seat back 4, regardless of how the sets of teeth 28a on the locking members 26a are disposed angularly relative to the corresponding set of teeth 30a on the moving cheek plate 12a of the first hinge 5a. Similarly, since the second hinge 5b is provided with locking members 26b mounted to float relative to the stationary cheek plate 10a, the sets of teeth 28b on said locking members 26b mesh automatically and fully with the set of teeth 30b on the moving cheek plate 12b. All of these provisions thus make it possible for the locking members 26a of the first hinge 5a to engage fully into the set of teeth 30a on the moving cheek plate 12a, regardless of the angular offset between the stationary cheek plate and the moving cheek plate of the first hinge 5a. The second hinge 5b also locks automatically but with a certain amount of circumferential play which allows the moving cheek plate to move angularly to a small extent relative to the fixed cheek plate, even in the locked state. Thus, while the seat is in normal use, this hinge mechanism thus operates as if only one hinge were provided, namely the first hinge 5a. Conversely, when the vehicle is subjected to a sudden impact, the circumferential play in the first hinge 5a is taken up by the moving cheek plate moving towards the stationary cheek plate, thereby making it possible to have a hinge mechanism made up of two hinges, without having major angular adjustment constraints when assembling the two hinges onto the seat.

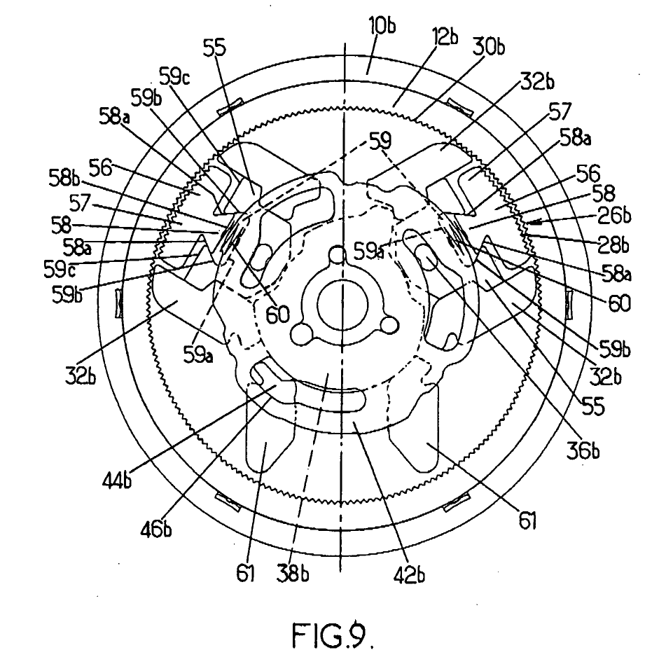

FIGS. 9 to 11 show a second embodiment of the second hinge 5b.

In this second embodiment, each locking member 26b comprises firstly a slug carrier 55 mounted to slide radially only, between two guides 32b, the slug carrier serving to co-operate with the control device of the second hinge 5a, and secondly a slug 56 which is provided with the set of teeth 28b and which serves to co-operate with the set of teeth 30b on the moving cheek plate 12b.

In this embodiment, the control device comprises:

a metal cam 38b which is secured to the handle 8 and to the coupling bar 9, and which causes the slug carrier 55 to slide radially;

a spring (not shown), e.g. mounted in a stamped dish-shaped setback formed in the stationary flange 10b, urging the cam 38b in the angular direction 27 towards a rest position in which said cam pushes the slug carrier 55 towards the set of teeth 30b on the moving cheek plate 12b, it being possible for said cam 38b to pivot in the opposite angular direction under the action of the handle 8; and

a control mask 42b formed by a rigid metal plate 42b which is coupled rigidly to the cam 38b and which extends radially between said cam and the moving cheek plate 12b while covering the slug carrier 55 in part, said plate also being provided with two cutouts 44b in which respective ones of two pegs 36b are engaged, which pegs are carried by respective ones of the two slug carriers 55, each of the pegs co-operating with a cam edge 46b which defines the corresponding cutout radially outwards, and which is shaped to co-operate with the corresponding peg 36b so as to move the corresponding slug carrier 55 radially inwards when the cam 38b pivots in the angular direction 25.

The slug 56 of each locking member 26b has a wide head 57 provided with the set of teeth 28b, and a projecting rear portion 58 provided with two lateral edges 58a that diverge radially inwards to a plane end edge 58b. Said projecting rear portion 58 of the slug 56 is mounted on the slug carrier 55 with circumferential play that is equal to not less than twice the distance between two adjacent teeth of the set of teeth 30b on the moving cheek plate 12b of the second hinge 5b.

To this end, each slug carrier 55 is provided with a notch 59 having a central wall 59a that is substantially flat and that is extended by two side edges 59b which diverge radially outwards. The inclination of the side edges 58a of the projecting portion 58 of the slug is substantially identical to the inclination of the side edges 59b of the notch 59 in the slug carrier 55.

In addition, each locking member 26b is provided with a spring 60 disposed in the notch 59 and between the central wall 59a and the projecting rear wall 58 of the slug 56. The spring 60 resiliently urges the side edges 58a of the slug 56 against the side walls 59b of the slug carrier 55, when the locking member 26b is in the retracted position as shown in FIG. 9. In the retracted position, the slug carrier 55 is in its maximum inwardly-retracted position so that the set of teeth 28b on the slug 56 no longer co-operate with the set of teeth 30b on the moving cheek plate 12b. In this configuration, the slug 56 is automatically re-centered relative to the slug carrier 55 by means of the resilient drive from the spring 60 which presses the two side edges 58a against the inclined side walls 59b of the notch 59 in said slug carrier 55;

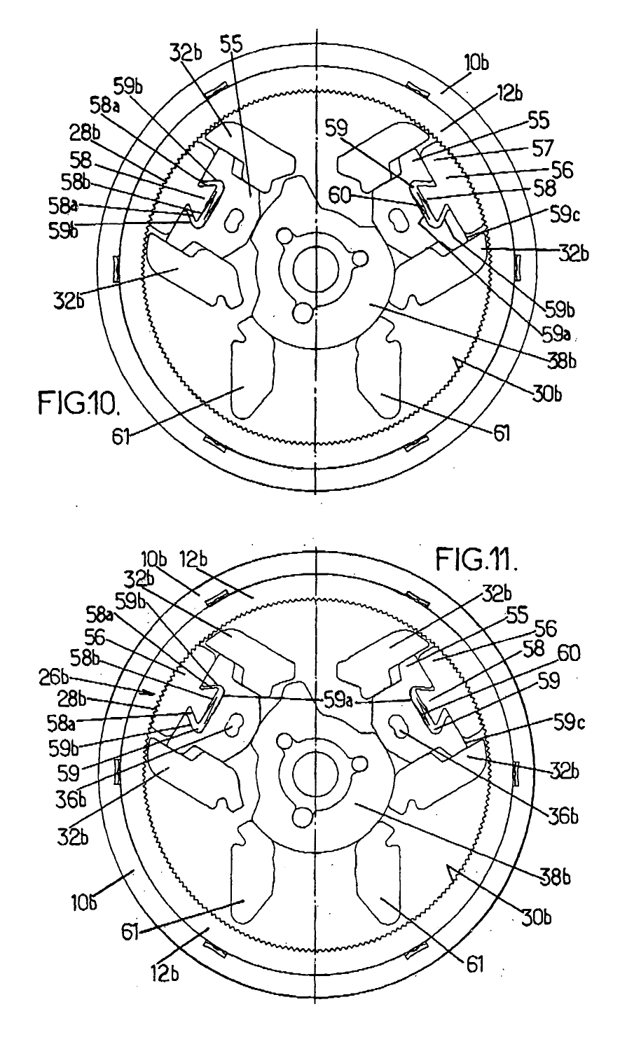

When the cam 38b is brought to its rest position in the angular direction 27, under the effect of the central spring, each slug carrier 55 then slides radially between the two guides 32b that are associated with it, thereby also driving the slug 56 towards the set of teeth 30b under the drive from the spring 60. So long as the set of teeth 28b on each slug 56 does not co-operate with the set of teeth 30b on the moving cheek plate 12b, the slugs 56 move radially only, towards said set of teeth 30b. When the set of teeth 28b comes into contact with the set of teeth 30b, and if the two sets of teeth are exactly in register, as shown in FIG. 10, the set of teeth 28b on each slug 56 then meshes fully with the set of teeth 30b, while the slug carrier 55 continues to move towards the set of teeth 30b until its abutment surfaces 59c come into contact with the head 57 of the slug, thereby strongly pressing the set of teeth 28b on each slug 56 against the set of teeth 30b on the moving cheek plate 12b.

When the sets of teeth 28b on the slugs 56 are not in register with the set of teeth 30b on the moving cheek plate 12b, as shown in FIG. 11, said slugs 56 slide also radially without any circumferential play so long as the sets of teeth 28b do not co-operate with the set of teeth 30b on the moving cheek plate 12b. As soon as the sets of teeth 28b co-operate with the set of teeth 30b, the slugs 56 are then moved circumferentially by a distance proportional to the angular offset in phase between the sets of teeth, until said sets of teeth 28b mesh fully with the sets of teeth 30b, the projecting rear portion 58 of the slug 56 then moving into the notch 59. The bearing surfaces 59c of the slug carrier 55 then come into contact with the head 57 of the slug 56 so as to press the set of teeth 28b strongly against the set of teeth 30b on the moving cheek plate 12b.

In this second embodiment, there are two locking members 26b. The stationary cheek plate 10b may then be provided with two abutment members 61 disposed so that the cam 38b comes to press radially against the abutment members 61 so as to counterbalance the radial forces that can be exerted by the slug carrier 55 on said cam 38b when pivot torque is applied between the stationary cheek plate and the moving cheek plate in the second hinge 5b.

What is claimed is:

1/ A vehicle seat having first and second sides, said seat comprising a seat proper and a seat back mounted to pivot relative to the seat proper by means of a hinge mechanism comprising first and second hinges which are respectively disposed on the first and second sides of the seat, and each which comprises:
first and second cheek plates mounted to pivot relative to each other about an pivot axis that is common to the first and second hinges, both of the first cheek plates of the first and second hinges being secured to a first seat element selected from the seat proper and the seat back, while the second cheek plates of the first and second cheek plates are secured to a second seat element chosen from the seat proper and the seat back, the second cheek plate of each hinge being provided with a first set of teeth forming at least one circular arc centered on the pivot axis;
a plurality of locking members, each of which is provided with a second set of teeth having an angular pitch that is identical to the angular pitch of the first set of teeth, each locking member being mounted to move on the first cheek plate in a substantially radial direction between firstly an active position in which the second set of teeth of each locking member is in engagement with the first set of teeth of the second cheek plate so as to prevent the first and second cheek plates from moving relative to each other, and secondly a retracted position in which the second set of teeth of each locking member does not co-operate with the first set of teeth of the second cheek plate so as to enable the first and second cheek plates to pivot relative to each other; and
a control device suitable for placing the plurality of locking members either in the active position or in the retracted position, the seat further comprising a mechanical coupling which interconnects the control devices of the first and second hinges;
wherein each locking member of the first hinge is mounted to move radially only on the first cheek plate of said first hinge, and wherein each locking member of the second hinge is further mounted on the first cheek plate of said second hinge with a certain amount of play in a direction that is circumferential to the radial direction so as to make it possible, when each locking member of the second hinge is in its active position, for each second set of teeth to mesh fully with the first set of teeth of the second hinge.

2/ A seat according to claim 1, in which the circumferential play of the second set of teeth of each locking member of the second hinge is equal to not less than twice the distance between two adjacent teeth of the first set of teeth of said second hinge.

3/ A seat according to claim 1, in which, when each locking member is in the retracted position, the first cheek plate and each locking member of the second hinge are adapted to enable each second set of teeth of said locking members to be placed in an identical position relative to said first cheek plate of the second hinge.

4/ A seat according to claim 1, in which each locking member of the second hinge is mounted to slide in the radial direction between two guides that are normally separated from the locking member by said circumferential play.

5/ A seat according to claim 4, in which the two guides have respective bearing zones, at least one of which serves to make substantially point contact with the locking member when it is in the active position.

6/ A seat according to claim 4, in which the two guides of each locking member are adapted to co-operate with respective ones of two bearing edges belonging to the locking member by applying said locking member against the first set of teeth of the second hinge by a wedging effect when the hinge mechanism is subjected to torque greater than a normal value.

7/ A seat according to claim 6, in which the two bearing edges of each locking member form respective wedges with the second set of teeth of said locking members, which wedges project laterally on either side of said locking member.

8/ A seat according to claim 1, in which each locking member comprises firstly a slug carrier mounted to slide radially only between two guides, the slug carrier serving to co-operate with the control device of the second hinge, and secondly a slug provided with the second set of teeth serving to co-operate with the first set of teeth of the second hinge, said slug being mounted on the slug carrier with play equal to not less than said circumferential play.

9/ A seat according to claim 8, in which the slug includes a projecting portion which diverges radially inwards and which is held captive with play in a notch in the slug carrier, the projecting portion of said slug being urged against the notch in the slug carrier by a spring disposed between the slug and said slug carrier, and, when the locking member is in the active position, the slug carrier has a bearing surface which pushes the slug back against the second cheek plate so as to cause the second set of teeth of the slug to co-operate with the first set of teeth of said second cheek plate.

10/ A seat according to claim 1, in which the control device of the second hinge comprises:
a rotary cam which is urged resiliently towards a rest position in which said cam places each locking member in the active position; and
a control plate which is secured to the cam and which covers each locking member at least in part, said control plate being provided with cutouts adapted to cooperate with projecting pegs provided on each locking member so as to move each locking member simultaneously towards the retracted position when the cam is moved into an actuating position.

11/ A seat according to claim 1, in which the control device of the second hinge comprises:
a plurality of springs which connect respective ones of the plurality of locking members to the first cheek plate of the second hinge, each spring urging the locking member that is associated with it towards the active position; and
a rotary control plate which is urged resiliently towards a rest position and which covers each locking member at least in part, said control plate being provided with cutouts adapted to co-operate with projecting pegs provided on each locking member so as to move each locking member simultaneously towards the retracted position when said control plate is moved to an actuating position.

12/ A seat according to claim 11, in which each cutout in the control plate has a ramp-shaped cam edge which is adapted to hold the corresponding locking member in the active position when the control plate is in the rest position.

13/ A seat according to claim 1, in which the mechanical coupling is a lost-motion mechanical coupling which interconnects the control devices of the first and second hinges with a certain amount of angular play, the mechanical coupling being adapted to enable the control device of the second hinge to place the locking members in the active position when the control device of the first hinge is driven to move the locking members of said first hinge from the retracted position to the active position, said mechanical coupling further being adapted to enable the control devices of the first and second hinges to place the locking members of said first and second hinges simultaneously in the retracted position.
